(19) United States
(12) Patent Application Publication
(10) Pub. No.: US 2021/0133390 A1
(43) Pub. Date: May 6, 2021

(54) CONCEPTUAL GRAPH PROCESSING APPARATUS AND NON-TRANSITORY COMPUTER READABLE MEDIUM

(71) Applicant: FUJI XEROX CO., LTD., Tokyo (JP)

(72) Inventor: Yuki TAGAWA, Kanagawa (JP)

(73) Assignee: FUJI XEROX CO., LTD., Tokyo (JP)

(21) Appl. No.: 16/989,035

(22) Filed: Aug. 10, 2020

(30) Foreign Application Priority Data
Nov. 1, 2019 (JP) 2019-200119
Feb. 6, 2020 (JP) 2020-019001

(51) Int. Cl. G06F 40/157; G06T 11/20

(52) U.S. Cl. CPC G06F 40/157; G06T 11/206

(57) ABSTRACT

A conceptual graph processing apparatus includes a processor configured to, based on a descriptive text group for a concept group including plural existing concepts included in an existing conceptual graph and a new concept not included in the existing conceptual graph, generate a conceptual word graph which represents a relation between the concept group and a word group included in the descriptive text group; and generate an extended conceptual graph including the new concept based on the conceptual word graph.

### CROSS-REFERENCE TO RELATED APPLICATIONS

This application is based on and claims priority under 35 USC 119 from Japanese Patent Applications No. 2019-200119 filed on Nov. 1, 2019 and No. 2020-019001 filed on Feb. 6, 2020.

### BACKGROUND

### (i) Technical Field

The present disclosure relates to a conceptual graph processing apparatus and a non-transitory computer readable medium.

### (ii) Related Art

Various techniques have been proposed to deal with knowledge by a computer. A conceptual graph is known as one of the techniques. A conceptual graph is a graph obtained by systematizing knowledge using conceptual relations. Specifically, a conceptual graph is configurated by multiple nodes (hereinafter, referred to as a concept group in some cases), and multiple edges each indicating a connection relation between nodes (in other words, a connection relation between concepts). In a conceptual graph, in some cases, each node is given a label which symbolizes a concept, and each edge is given a label which symbolizes a connection relation. In some cases, a conceptual graph is called an ontology graph.

Various techniques have been proposed to calculate a vector as a distributed representation for each node and each edge configurating a conceptual graph. Japanese Unexamined Patent Application Publication No. 2018-156332 describes an example of the techniques. The technique is based on well-known TransE.

In general, a conceptual graph includes multiple triples. Each triple consists of a head, a relation, and a tail, and typically, those correspond to a subject, a predicate or relation, and an object. In the above-mentioned TransE, an optimal vector set to be given to an element group included in a conceptual graph is retrieved so that a predetermined loss function value reaches a minimum. Practically, an optimal vector set is derived by utilizing machine learning. Such a distributed representation makes it easy to utilize knowledge represented by a conceptual graph in information processing.

### SUMMARY

When a concept (hereinafter referred to as a new concept) which is new to the existing conceptual graph is desired to be added, any conceptual graph processing apparatus has been unable to identify the relation between the multiple existing concepts (hereinafter referred to as existing concepts) included in a conceptual graph and a new concept. Therefore, all the processing of adding a new concept to the conceptual graphs needs to be performed by a manual operation.

Aspects of non-limiting embodiments of the present disclosure relate to a conceptual graph processing apparatus capable of adding a new concept to the existing conceptual graph while reducing the load of a user, as compared with when all the processing of adding a new concept is performed by a manual operation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a conceptual graph processing apparatus including a processor configured to, based on a descriptive text group for a concept group consisting of a plurality of existing concepts included in an existing conceptual graph and a new concept not included in the existing conceptual graph, generate a conceptual word graph which represents a relation between the concept group and a word group included in the descriptive text group; and generate an extended conceptual graph including the new concept based on the conceptual word graph.

### BRIEF DESCRIPTION OF THE DRAWINGS

Exemplary embodiments of the present disclosure will be described in detail based on the following figures, wherein:

FIG. 1 is a conceptual chart illustrating a conceptual graph processing method according to a first exemplary embodiment;

FIG. 2 is a block diagram illustrating the configuration of a conceptual graph processing apparatus according to the first exemplary embodiment;

FIG. 3 is a table illustrating an example of multiple descriptive texts for multiple concepts;

FIG. 4 is a table illustrating an example of a descriptive text for a new concept;

FIG. 5 is a table illustrating an example of a group list referred to in pre-processing (name unification processing);

FIG. 6 is a table illustrating an example of change of a descriptive text before and after the pre-processing;

FIG. 7 is a chart illustrating an example of an importance degree matrix;

FIG. 8 is a chart illustrating a vector set learning method;

FIG. 9 is a flowchart illustrating conceptual graph processing according to the first exemplary embodiment;

FIG. 10 is a flowchart illustrating a method of generating an extended conceptual graph;

FIG. 11 is a conceptual chart illustrating a conceptual graph processing method according to a second exemplary embodiment;

FIG. 12 is a block diagram illustrating a processor according to the second exemplary embodiment;

FIG. 13 is a chart illustrating an example of a similarity degree matrix;

FIG. 14 is a conceptual chart illustrating a conceptual graph processing method according to a third exemplary embodiment;

FIG. 15 is a conceptual chart illustrating another example of an extended conceptual graph;

FIG. 16 is a conceptual chart illustrating a modification; and

FIG. 17 is a chart illustrating a specific example of a new edge addition method.

### DETAILED DESCRIPTION

Hereinafter, an exemplary embodiment will be described in detail with based on the drawings.

### (1) Summary of Exemplary Embodiment

A conceptual graph processing apparatus according to the exemplary embodiment includes a processor. The processor serves as a conceptual word graph generator, an extended conceptual graph generator, and an extended vector set generator. More specifically, based on a descriptive text group consisting of multiple existing concepts included in the existing conceptual graph and a new concept not included in the existing conceptual graph, the processor generates a conceptual word graph which represents a relation between the concept group and a word group included in the descriptive text group. Subsequently, the processor generates an extended conceptual graph including the new concept based on the conceptual word graph.

In the above-described configuration, a new concept is embedded in an existing conceptual graph (hereinafter referred to as an existing conceptual graph) using the conceptual word graph. The conceptual word graph exists between a layer (which is called an upper layer for the sake of convenience) in which a concept group exists and a layer (which is called a lower layer for the sake of convenience) in which a word group exists, and defines the relation between the concept group and the word group. Even when the relation between the multiple existing concepts and a new concept is not identifiable in the upper layer, it is possible to clarify how the new concepts is related to the multiple existing concepts by referring to the conceptual word graph, in other words, by taking the structure built lower than the upper layer into consideration.

In the exemplary embodiment, a conceptual graph is formed by multiple nodes as a concept group and multiple edges each indicating a connection relation (that is, a connection relation between concepts) between nodes. As described above, the conceptual word graph defines the relation between the concept group and the word group. In the exemplary embodiment, the conceptual word graph includes multiple nodes as the concept group and multiple nodes as the word group, and further includes multiple edges which indicate the connection relation in the node set.

A descriptive text group includes, for instance, multiple texts which describe a relation between concepts and a relation between concept words. The descriptive text group includes a descriptive text for a new concept. A new concept to be added may be selected by a user or selected automatically. Multiple new concepts may be added at the same time. A vector is to be individually given to each node or each edge, and is a distributed representation of a graph element. In the exemplary embodiment, an extended conceptual graph is generated based on the conceptual word graph. The existing conceptual graph may be combined with the conceptual word graph, and a new edge may be identified from a vector set calculated based on the combined graph, or a vector set calculated based on the existing conceptual graph may be combined with a vector set calculated based on the conceptual word graph, and a new edge may be identified from the combined vector set. A new edge basically identifies the relation between a new concept and the existing concepts. An extended conceptual graph is generated by adding a new edge to the existing conceptual graph. It is sufficient that the extended conceptual graph be a graph generated based on the conceptual word graph, and in this limited sense, the concept of the conceptual graph may include various types of graphs.

In the above-described configuration, an existing concept is an element of the existing conceptual graph already generated and managed, and is distinguished from the words which are not the elements of the existing conceptual graph. Even when a concept and a word having the same name exist, those are dealt with independently from each other.

In the exemplary embodiment, the processor generates a matrix including multiple elements which represent the degree of connection between a concept group and a word group. In addition to that, the processor generates a conceptual word graph based on the matrix. The above-mentioned matrix defines the mutual relationship between a concept group and a word group. In the exemplary embodiment, each element is a numerical value calculated for each pair of a concept and a word, and for instance, is a numerical value indicating the importance degree of a word to a concept. Various types of coefficients may be utilized as the importance degree.

In the exemplary embodiment, the processor generates an intermediate structure including one or more edges between the concept group and the word group based on the matrix. The intermediate structure forms the substantial body of the conceptual word graph. It is to be noted that the term intermediate is used in the description of the present application with focus on the point that the structure exists between the upper layer and the lower layer.

In the exemplary embodiment, the processor calculates multiple similarity degrees indicating an inter-word relation in the word group. In addition to that, for the word group, the processor generates a word group structure including one or multiple edges based on the multiple similarity degrees. In this case, the conceptual word graph includes the word group structure in addition to the intermediate structure. The word group structure defines the relation between words. It is possible to appropriately identify the relation between a new concept and multiple existing concepts by adding the word group structure to the intermediate structure.

In the exemplary embodiment, the processor combines the existing conceptual graph and the conceptual word graph. In addition to that, the processor calculates a vector set for multiple graph elements included in the combined graph based on the combined graph. Subsequently, the processor generates an extended conceptual graph by creating one or multiple new edges between multiple existing concepts and a new concept based on the vector set. Combining the existing conceptual graph and the conceptual word graph enables calculation of a vector for each individual graph element with consideration the entire graphs. The vector set calculated to generate a new edge corresponds to the later-described temporary vector set in the exemplary embodiment. The vector set is re-calculated as needed based on the extended conceptual graph. However, all or part of the vector set calculated to generate a new edge may be used as all or part of the re-calculated final vector set. The vector set may be calculated by a general vector calculation method.

In the exemplary embodiment, a vector set is generated as a result of machine learning based on the combined graph. Various methods may be utilized as a machine learning method. In general, a combination of multiple vectors which optimize the value of an evaluation function (for instance, a loss function), in other words, an optimal vector set is found by machine learning.

In the exemplary embodiment, based on the existing conceptual graph, the processor calculates a first vector set for multiple graph elements included in the existing conceptual graph. In addition, based on the conceptual word graph, the processor calculates a second vector set for multiple graph elements included in the conceptual word graph. In addition to that, the processor combines the first vector set calculated based on the existing conceptual graph and the second vector set calculated based on the conceptual word graph, thereby generating an extended vector set. Subsequently, the processor generates an extended conceptual graph based on the extended vector set.

In the above-described configuration, without combining the conceptual graph and the conceptual word graph, the first vector set and the second vector set generated from the graphs are combined, and an extended conceptual graph is generated from a result of the combining of the vector sets. In general, a vector set is formed by a vector calculated for each graph element. In the exemplary embodiment, the first vector set is calculated by utilizing a first machine learner, and the second vector set is calculated by utilizing a second machine learner. Each individual machine learner is substantially a so-called machine learning model.

In the exemplary embodiment, the processor applies pre-processing to the descriptive text group so that words having the same meaning are replaced by the same word. In addition to that, the processor generates a conceptual word graph based on the descriptive text group to which pre-processing is applied. The pre-processing may include so-called name unification processing. Another pre-processing may be performed to achieve appropriate graph generation.

A conceptual graph processing method according to the exemplary embodiment includes a first step and a second step. In the first step, based on a descriptive text group consisting of multiple existing concepts included in the existing conceptual graph and a new concept not included in the existing conceptual graph, a conceptual word graph which represents a relation between the concept group and a word group included in the descriptive text group is generated. In the second step, an extended conceptual graph including the new concept is generated based on the conceptual word graph.

The above-described method can be implemented as the function of hardware or as the function of software. In the latter case, a program for executing the method is installed in the information processing apparatus via a portable recording medium or a network. The concept of the information processing apparatus includes a computer that functions as a conceptual graph processing apparatus. It is to be noted that the conceptual graph processing method may be executed as part of a cloud service on the Internet.

### (2) Details of Exemplary Embodiment

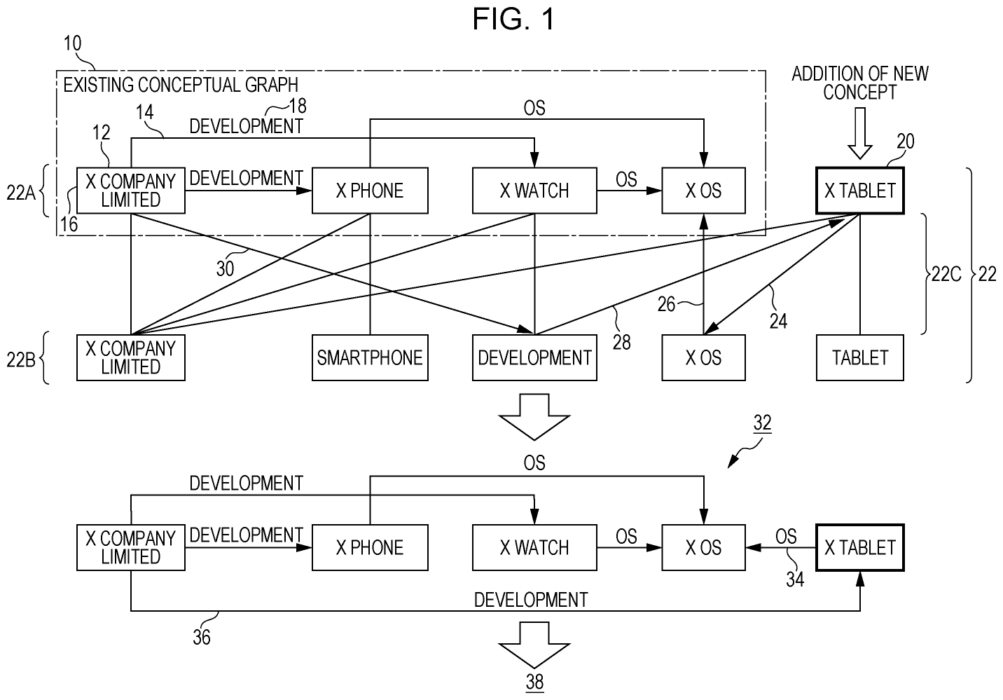

FIG. 1 illustrates a conceptual graph processing method according to a first exemplary embodiment as a conceptual chart. An existing conceptual graph 10 illustrated on the upper part of FIG. 1 is a conceptual graph already generated and managed. The existing conceptual graph 10 is obtained by systematizing knowledge. Specifically, the existing conceptual graph 10 is formed by multiple nodes 12 as a concept group and multiple edges 14 each indicating a connection relation (that is, a connection relation between concepts) between nodes. Each node 12 is given a label 16 which symbolizes a concept, and each edge 14 is given a label 18 which symbolizes a connection relation. Each edge 14 has a direction.

The existing conceptual graph 10 includes multiple triples. Each triple consists of three elements: a head (a node from which an edge originates), a relation (an edge), and a tail (a node to which an edge leads). The three elements correspond to a subject (s), a predicate or relation (r), and an object (o). In the example illustrated, “X CORPORATION” corresponds to the subject, “DEVELOPMENT” corresponds to the predicate or relation, and “X WATCH” corresponds to the object, for instance.

Here, addition of a new concept 20 to the existing conceptual graph 10 will be discussed. When the relation between the new concept 20 and the multiple existing concepts is unknown, it is not possible to automatically embed the new concept 20 in the multiple existing concepts. The relation has to be clarified by a manual operation or an edge has to be added by a manual operation. Such a manual operation imposes a large load on a user.

In the exemplary embodiment, the new concept 20 can be easily added to the existing conceptual graph 10 automatically. This will be described in detail.

A descriptive text group is identified or collected, which consists of multiple descriptive texts for the existing concept group included in the existing conceptual graph and one or multiple descriptive texts for the new concept. A conceptual word graph 22 is created based on the descriptive text group. The conceptual word graph 22 defines the relation between a concept group and a word group including multiple words, the concept group including multiple existing concepts and the new concept 20 not included in the existing concepts. One or multiple edges are provided between the concept group and the word group, in other words, the concept group and the word group are related to each other by one or multiple edges. It is to be noted that in FIG. 1, in order to avoid complexity, expression of arrow is omitted for the edges in part of the conceptual word graph. Practically, each individual edge has a direction. However, use of a bidirectional edge may be considered.

When the concept group is expressed as an upper layer 22A and the word group is expressed as a lower layer 22B, an intermediate structure 22C is defined by one or multiple edges which exist between the layers. With the intermediate structure 22C, it is possible to indirectly identify the relation between one or multiple existing concepts and the new concept 20 which is isolated in the upper layer 22A. For instance, a new concept “X TABLET” is related to the word “XOS” by an edge 24, and the word “XOS” is related to the concept “XOS” by an edge 26. The relation between the new concept “X TABLET” and the concept “XOS” can be identified by such a connection relation (actually, a vector relation described later).

Similarly, the concept “X COMPANY” is related to the word “DEVELOPMENT” via an edge 30, and the word “DEVELOPMENT” is related to the new concept “X TABLET” by an edge 28. The relation between the concept “X COMPANY” and the new concept “X TABLET” can be identified by such a connection relation (actually, a vector relation described later). In this manner, with the conceptual word graph 22, a relation which is unrecognizable in the upper layer can be recognizable.

The lower part of FIG. 1 illustrates a conceptual graph (hereinafter referred to as an extended conceptual graph) 32 which is added with a new concept and extended. An edge 34 is added, which originates from the new concept “X TABLET” and leads to the concept “XOS”. The edge 34 is assigned “OS” as a label. Similarly, an edge 36 is added, which originates from the concept “X COMPANY” and leads to the concept “X TABLET”. The edge 36 is assigned “DEVELOPMENT” as a label. The extended conceptual graph 32 can be automatically generated, thus the load of a user can be eliminated or reduced. However, part of an operation or confirmation may be performed by a user. Even in that case, the load of a user is reduced, as compared with when a new concept is added entirely by a manual operation.

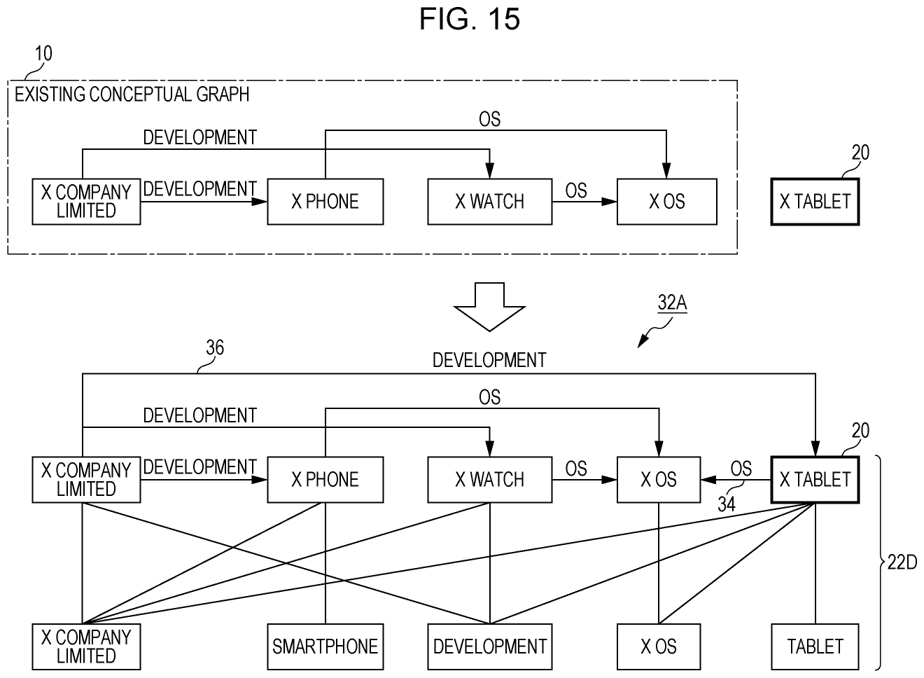

It is to be noted that in the example illustrated in FIG. 1, when the extended conceptual graph 32 is generated, the conceptual word graph 22 is excluded (in other words, the extended conceptual graph 32 does not include a portion corresponding to the conceptual word graph 22), however, the conceptual word graph 22 may not be excluded. This will be described later with reference to FIG. 15.

Normally, as indicated by a symbol 38, based on the extended conceptual graph 32, a distributed representation (in short, a vector) of the individual graph elements included in the extended conceptual graph 32 is obtained. A vector set consisting of multiple vectors is used to search for a similar word or a related word. Although one new concept is added in FIG. 1, multiple new concepts may be added at the same time. The dimension of the vector is 100, for instance.

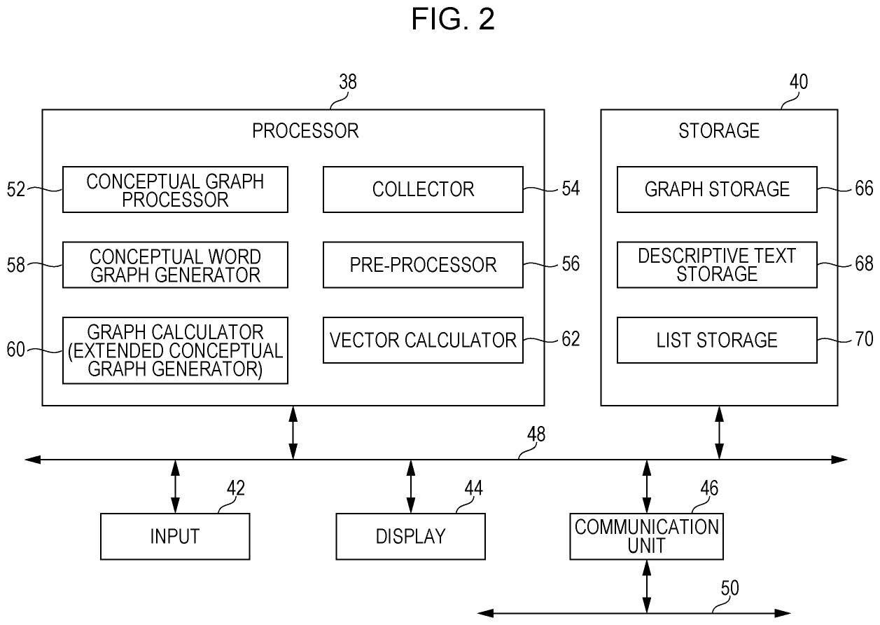

FIG. 2 illustrates a configuration example of a conceptual graph processing apparatus according to the first exemplary embodiment. In the example illustrated, the conceptual graph processing apparatus is constructed on a computer. Specifically, the conceptual graph processing apparatus has a processor 38, a storage 40, an input 42, a display 44, and a communication unit 46. Those components are connected in parallel to an internal bus 48. The communication unit 46 is connected to a network 50. The conceptual graph processing apparatus exchanges data via the network 50 with other apparatuses which are not illustrated.

The processor 38 executes a program, thereby achieving multiple functions. Those functions are represented by multiple blocks in FIG. 2. Specifically, in the configuration example illustrated, the processor 38 functions as a conceptual graph processor 52, a collector 54, a pre-processor 56, a conceptual word graph generator 58, a graph calculator 60, and a vector calculator 62. Incidentally, the graph calculator 60 functions as an extended conceptual graph generator.

The conceptual graph processor 52 provides various services according to a request by utilizing a conceptual graph which systematizes knowledge. For instance, when a request is received from another apparatus to search for a word related to a specified word (in short, a keyword), the conceptual graph processor 52 identifies one or multiple relational words related to the keyword, and returns a result of identification to another apparatus. In addition to this, the conceptual graph can be utilized for document identification or the like

The collector 54 collects descriptive texts as needed. When a new concept is given and a sufficiently descriptive text for the new concept is not stored in the conceptual graph processing apparatus, the collector 54 searches for and obtains such a descriptive text. A descriptive text may be collected by a user. Alternatively, a descriptive text owned by a user may be given to the conceptual graph processing apparatus. It is to be noted that the conceptual graph processing apparatus normally has multiple descriptive texts for the existing concept group, however, when the conceptual graph processing apparatus does not have those descriptive texts or the descriptive texts are insufficient, the conceptual graph processing apparatus may cause the collector 54 to collect descriptive texts which are needed.

The pre-processor 56 applies the later-described name unification processing to the descriptive texts as the pre-processing. The name unification processing is processing of replacing multiple words having a similar meaning by a specific word. When the name unification processing is performed before a conceptual word graph is generated, the quality of the conceptual word graph is improved.

The conceptual word graph generator 58 generates the conceptual word graph based on the descriptive text group. This will be specifically described later. The graph calculator 60 generates a combined graph by combining the existing conceptual graph and the conceptual word graph, and generates an extended conceptual graph in which a new concept is embedded by utilizing the combined graph. In the exemplary embodiment, the extended conceptual graph does not include the conceptual word graph. The conceptual word graph is a graph temporarily generated and utilized for calculation of the extended conceptual graph. However, the extended conceptual graph may own the conceptual word graph and utilize it later. The conceptual word graph may be embedded in the extended conceptual graph.

The vector calculator 62 calculates a vector set based on the combined graph and the extended conceptual graph. A vector is calculated for each graph element. For the calculation, a publicly known technique such as the TransE may be utilized. In the first exemplary embodiment, in the evaluation of individual triples included in the combined graph, a vector set is generated from the combined graph by the vector calculator 62. In the exemplary embodiment, the vector calculator 62 and the conceptual graph processor 52 each correspond to a machine learner.

The storage 40 includes a semiconductor memory, and a hard disk. The storage 40 has multiple storage areas, and among these storage areas, FIG. 2 illustrates a graph storage 66, a descriptive text storage 68, and a list storage 70.

In the graph storage 66, an existing conceptual graph is stored. In addition, a conceptual word graph and a combined graph needed for generation of an extended conceptual graph are stored in the graph storage 66. A vector set serving as a vector representation of individual graphs, in other words, a result of machine learning is also stored in the graph storage 66.

In the descriptive text storage 68, multiple descriptive texts for the existing concept group, and descriptive texts collected for new concepts are stored. The multiple descriptive texts stored therein are managed as a descriptive text group. Its content is updated as needed. In the list storage 70, a word group list which is referred to in the name unification processing is stored. A specific example will be described later.

The input 42 includes a keyboard, and a pointing device. The display 44 includes a display device such as an LCD. A server on a network may be formed by the configuration illustrated in FIG. 2. The configuration illustrated in FIG. 2 may be utilized as a cloud service on the Internet.

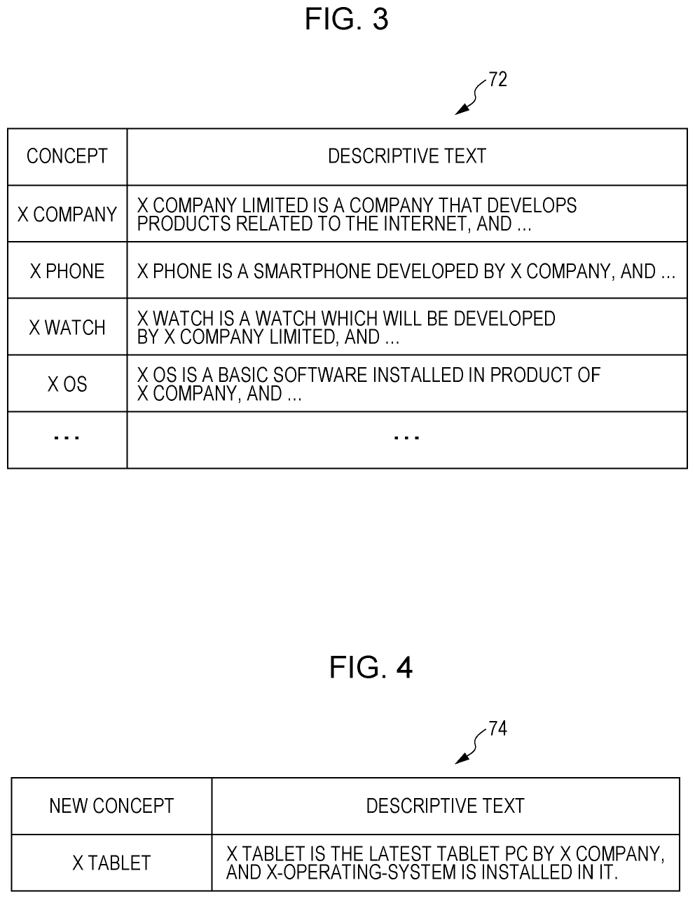

FIG. 3 illustrates a descriptive text group. In the example illustrated, a descriptive text group 72 includes multiple descriptive texts corresponding to multiple concepts. Each descriptive text is, for instance, a sentence that defines a corresponding concept included in the conceptual graph, and the descriptive text includes a subject, an object, and a verb. Normally, the subject and the object correspond to a concept. The verb corresponds to a relation. Multiple concepts may be defined by a single descriptive text, and one concept may be described by multiple descriptive texts.

FIG. 4 illustrates an example of a descriptive text for a new concept. In this example, a descriptive text 74 is for “X TABLET”.

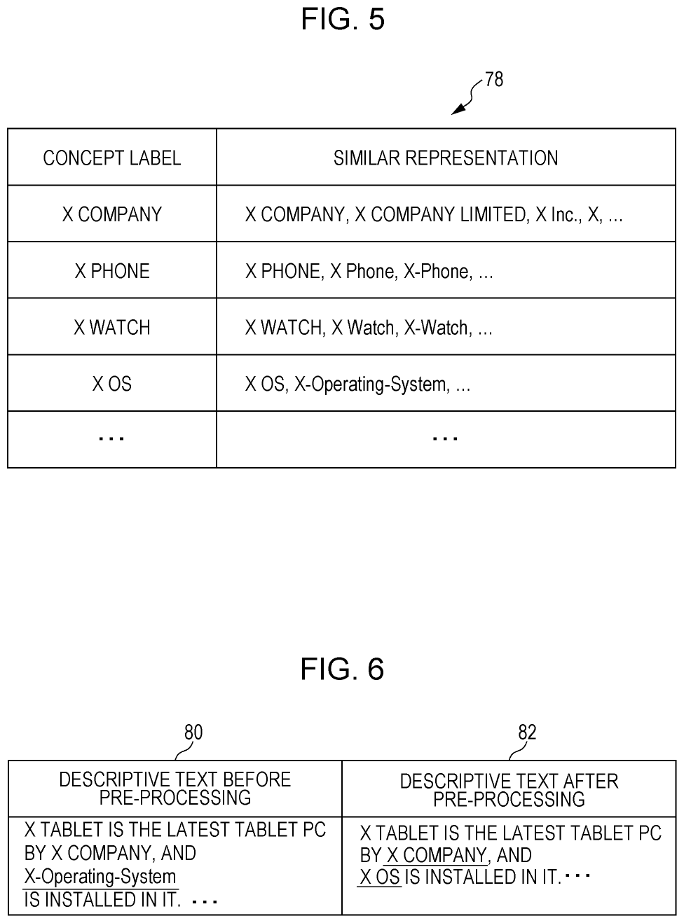

FIG. 5 illustrates a word group list referred to in the name unification processing which is pre-processing. In the illustrated word group list 78, the words or expressions similar to each other are grouped for each concept. When a word belongs to one of the groups, the word is replaced with a specific word (specifically, a label for a concept) which represents the group. The word group list 78 may be obtained from the outside, or may be created by a user.

FIG. 6 illustrates a descriptive text 80 before the pre-processing and a descriptive text 82 after the pre-processing. The descriptive text is processed in accordance with the name unification rule described above. Part of all of the name unification processing may be performed by a user.

Subsequently, the generation of a conceptual word graph based on the descriptive text group will be specifically described.

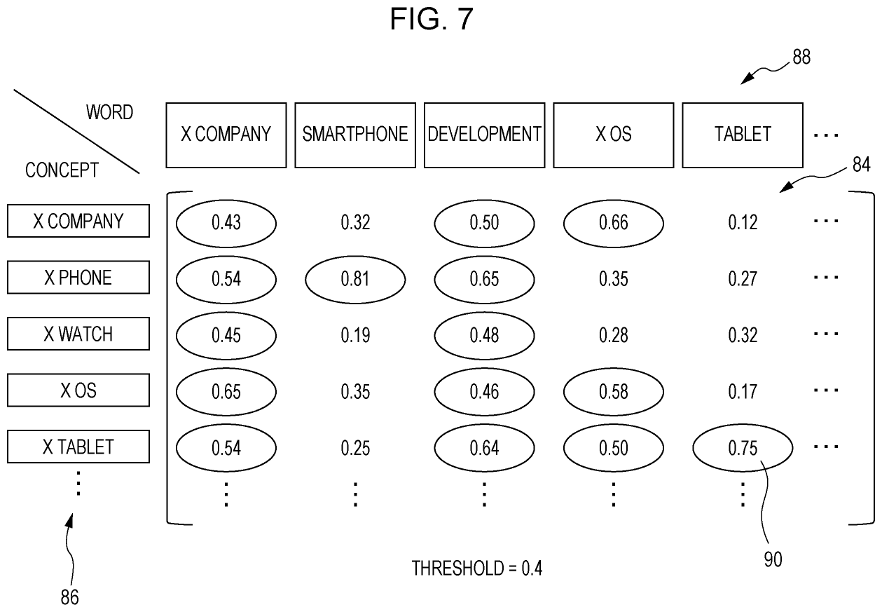

FIG. 7 illustrates an example of a matrix that forms the basis of the conceptual word graph. The matrix illustrated is an importance degree matrix 84. The vertical axis corresponds to a concept group 86, and multiple concepts forming the concept group 86 are arranged along the vertical axis. The concept group 86 includes multiple existing concepts and new concepts. The horizontal axis correspond to a word group 88, and multiple concepts forming the concept group 88 are arranged along the horizontal axis. The concept group 88 includes those words which are included in the descriptive text group and have a confirmed relation to one of the concepts. The concept group 88 may be formed by all of the words or part of the words included in the descriptive text group. The concept group 88 may be formed by a condition other than stated above.

An importance degree 90 is calculated for each pair of a concept and a word, and an importance degree matrix 84 is formed by multiple importance degrees 90 calculated. For instance, as an importance degree, a term frequency/inverse document frequency (TFIDF) may be calculated. An importance degree is understood as an importance degree of or strength of relation to a certain word from the perspective of a concept. The importance degrees may be normalized so that the total of importance degree vectors (row vectors) corresponding respective concepts equal to 1.

A threshold value may be set, and processing of replacing an importance degree having the threshold value or lower with 0 or processing of replacing an importance degree having the threshold or higher with 1 may be performed. In the example illustrated, 0.4 is set as the threshold value, and an importance degree higher than or equal to the threshold value is utilized to generate a conceptual word graph. Only those importance degrees which satisfy other selection conditions may be retrieved from the importance degrees higher than the threshold value.

As illustrated in FIG. 1, multiple edges are set between the concept group and the word group based on the multiple importance degrees satisfying a predetermined condition, and thus a conceptual word graph is formed. It is to be noted that at the time of setting of each edge, the direction of the edge can be determined in accordance with the triadic relation between the subject, the verb and the object in a descriptive text. Alternatively, the direction of the edge may be identified using another technique. Bidirectional edges may be adopted, and at the stage of generation of an extended conceptual graph, the direction of a newly added edge may be identified. Each edge included in the conceptual word graph is assigned an appropriate label as needed.

Subsequently, a combined graph is generated by combining the existing conceptual graph and the conceptual word graph. Simple connection may be listed as a composite form. In the first exemplary embodiment, in order to generate an extended conceptual graph from the combined graph, a vector set is calculated based on the combined graph, and the combined graph is evaluated based on the vector set. However, an extended conceptual graph may be generated from the combined graph by another technique. Also, an extended conceptual graph may be directly generated from the conceptual word graph.

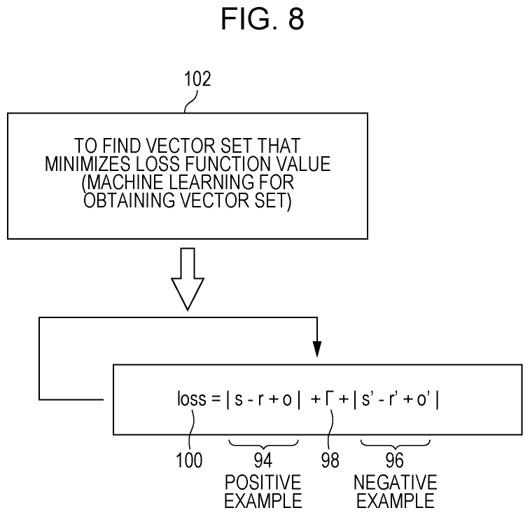

FIG. 8 illustrates an example of a vector set generation method. This is based on the TransE described above. The vector set is sequentially improved so that the loss function value (loss) defined by Expression (1) below (Expression (1) is also illustrated in FIG. 8). The vector set when the loss function value (see a symbol 100 in FIG. 8) reaches a minimum finally gives the vector set that represents the combined graph (see a symbol 102 in FIG. 8). The vector set generated in this stage may be called a temporary vector set from the perspective of the final vector set re-calculated based on the extended conceptual graph.

loss=|s−r+o|+Γ+|s′−r′+o′| (1)

In Expression (1), the first term (see a symbol 94 in FIG. 8) shows a positive example. The positive example is formed by a triple retrieved from the combined graph. Specifically, the triple consists of a vector s corresponding to the subject, a vector r corresponding to the predicate (that is, the relation), and a vector o corresponding to the object. In Expression (1), the third term (see a symbol 96 in FIG. 8) shows a negative example. The negative example is generated by replacing part of the positive example with a concept vector within the combined graph at random. It is to be noted that the second term included in Expression (1), that is F (see a symbol 98 in FIG. 8) is a margin parameter

The combined graph includes multiple triples, which are sequentially inputted to Expression (1). Concurrently, multiple negative examples corresponding to multiple triples are also sequentially inputted to Expression (1). The loss function value is a cumulative value obtained by inputting all triples included in the combined graph into Expression (1). In other words, the loss function value is calculated for each vector set given to the graph. For improvement of the vector set, the steepest descent method or the like is utilized. It is to be noted that vectorization of the combined graph can be implemented by utilizing various models. The above method provides only an example.

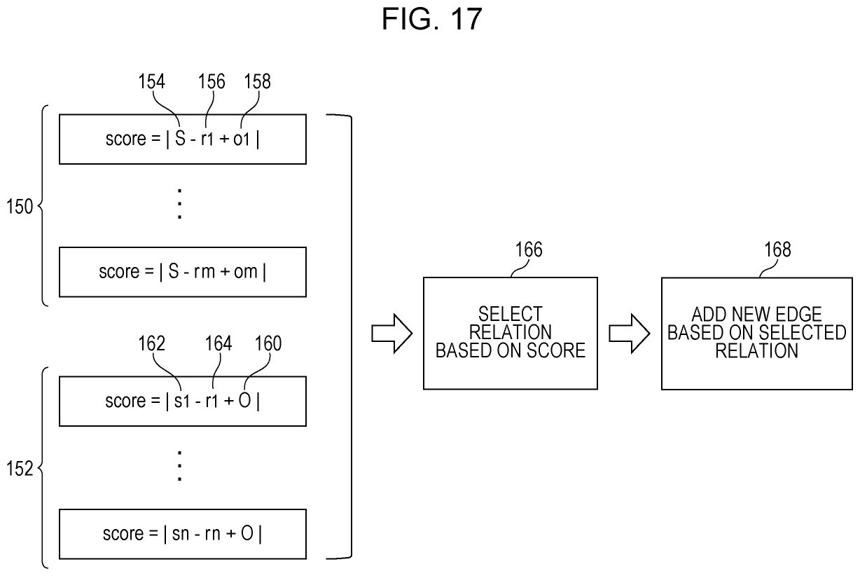

After the vector set for the combined graph is determined, the combined graph is evaluated based on the vector set. Specifically, an edge originating from a new concept or an edge leading to a new concept is generated and added. A specific example will be described in detail later with reference to FIG. 17. Various methods in addition to the above method allow an edge to be added to the existing conceptual graph. For instance, when the triple consisting of the concept “X TABLET”, the edge 24, and the word “XOS” satisfies a certain condition and the triple consisting of the word “XOS”, the edge 26, and the concept “XOS”, satisfies a certain condition in FIG. 1, an edge 34 originating from the concept “X TABLET” leading to the concept “XOS” may be newly generated. In that case, the edge 34 is assigned a label. For instance, a label can be identified from a concept or a word related to or included in the triple. Labeling may be performed by a user.

In addition, for instance, when the triple consisting of the concept “X COMPANY”, the edge 30, and the word “DEVELOPMENT” satisfies a certain condition and the triple consisting of the word “DEVELOPMENT”, the edge 28, and the concept “X TABLET”, satisfies a certain condition in FIG. 1, an edge 36 originating from the concept “X COMPANY” leading to the concept “X TABLET” may be newly generated. For instance, the edge 36 is assigned a label of “DEVELOPMENT” in the triple. Without using the word “DEVELOPMENT”, an edge may be determined when the distance defined by hector s−vector r+vector o| has a minimum value or is less than or equal to a certain value. A primary triple including a new concept is evaluated, a secondary triple connecting the primary triple is evaluated, and thus a new edge connecting the start point of the primary triple and the end point of the secondary triple may be generated. In addition to this, various edge addition methods may be used.

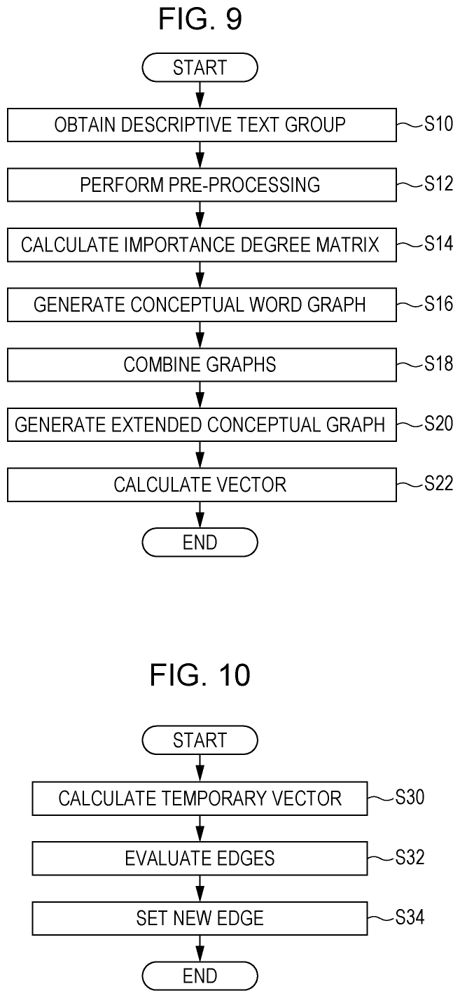

FIG. 9 illustrates the operation of the conceptual graph processing apparatus according to the first exemplary embodiment, particularly the operation when a new concept is added. When instructions to add a new concept are given, the process in S10 and later is executed. In S10, a descriptive text group including multiple descriptive texts for the existing concept group and a descriptive text for the new concept is obtained. At this point, a descriptive text group is newly collected as needed. In S12, pre-processing is applied to each individual descriptive text included in the descriptive text group. Specifically, the name unification processing is applied. In S14, an importance degree matrix to identify the relation between the concept group and the word group is calculated based on the descriptive text group after the pre-processing. Normalization processing as mentioned above may be applied to the importance degree matrix.

In S16, a conceptual word graph is generated based on the importance degree matrix. In S18, the existing conceptual graph and the conceptual word graph are combined, and a combined graph is generated. The two graphs may be logically combined. In S20, an extended conceptual graph including the new concept is generated based on the combined graph. In S22, the vector set is re-calculated based on the extended conceptual graph. For calculation of the vector set, a neural network or the like may be utilized.

FIG. 10 specifically illustrates the details of S20 illustrated in FIG. 9. The details is for illustration. In S30, a temporary vector is calculated based on the combined graph. In S32, each edge candidate originating from the new concept or leading to the new concept is evaluated based on the temporary vector. In S34, based on the edge, a new edge is set, thus an extended conceptual graph incorporating the new concept is generated.

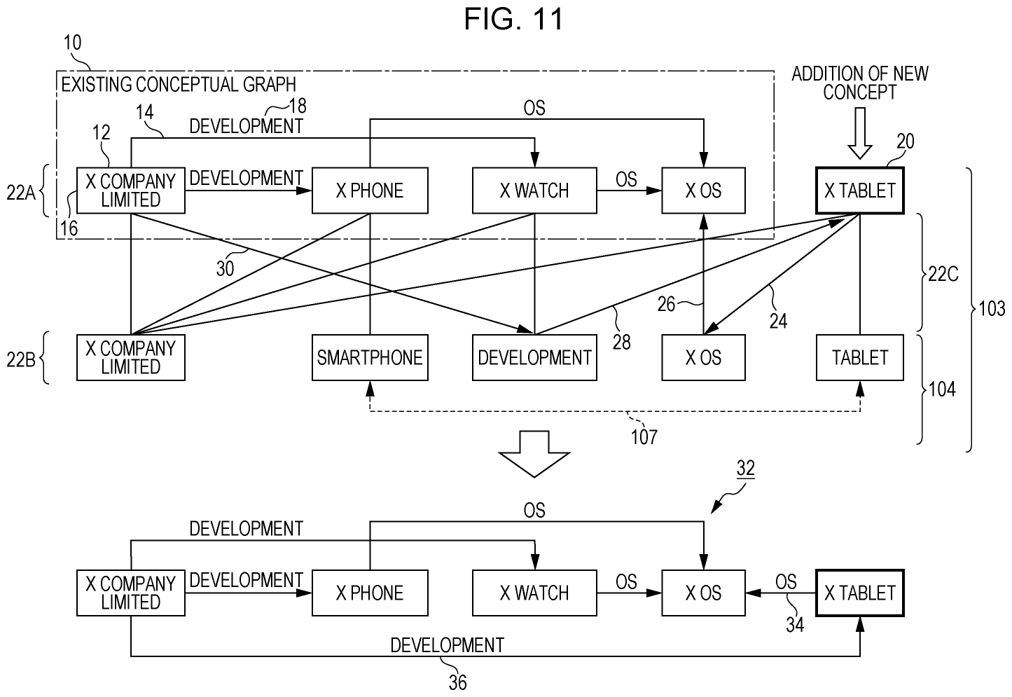

Next, a second exemplary embodiment will be described with reference to FIG. 11 to FIG. 13. FIG. 11 conceptually illustrates a conceptual vector processing method according to the second exemplary embodiment. It is to be noted that the same element as the element illustrated in FIG. 1 is labeled with the same symbol, and a description thereof is omitted.

In the second exemplary embodiment, a conceptual word graph 103 includes a word group structure 104 based on the similarity degree, in addition to the intermediate structure 22C. As illustrated, the word group structure 104 has one or multiple edges 107 indicating a similarity relation. It may be understood that the word group structure 104 is added to the conceptual word graph 103, and these two are treated in an integral manner. The word group structure 104 corresponds to the word graph.

The word group structure 104 includes an edge provided between a word pair which is confirmed to have a similarity degree higher than a certain level. The conceptual word graph 103 integrated with the word group structure 104, and the existing conceptual graph are combined, thereby generating a combined graph. One or multiple edges to relate the new concept to one or multiple existing concepts are set based on the combined graph. Thus, the extended conceptual graph 32 is generated. Similarly to the first exemplary embodiment, also in the second exemplary embodiment, the vector set is calculated based the combined graph, and edges are added based on the vector set.

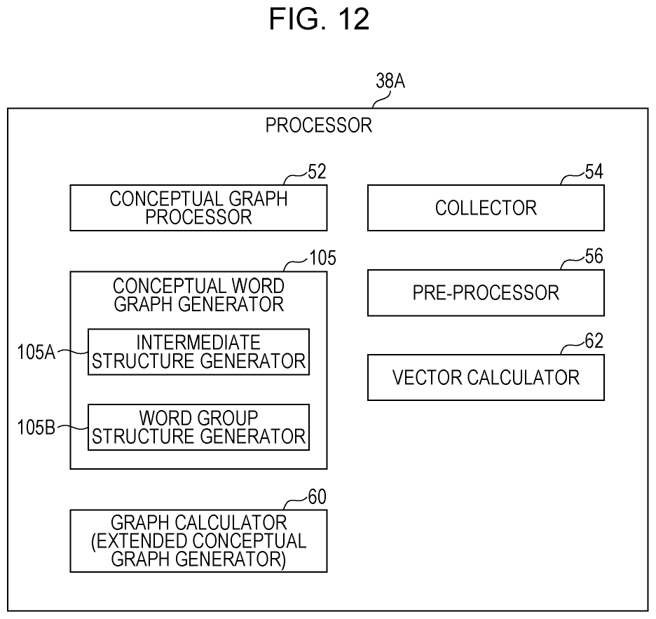

FIG. 12 illustrates the configuration of a processor 38A. In FIG. 12, the same element as the element illustrated in FIG. 2 is labeled with the same symbol, and a description thereof is omitted. In the second exemplary embodiment, a conceptual word graph generator 105 has a word group structure generator 105B in addition to an intermediate structure generator 105A. This point differs from the first exemplary embodiment.

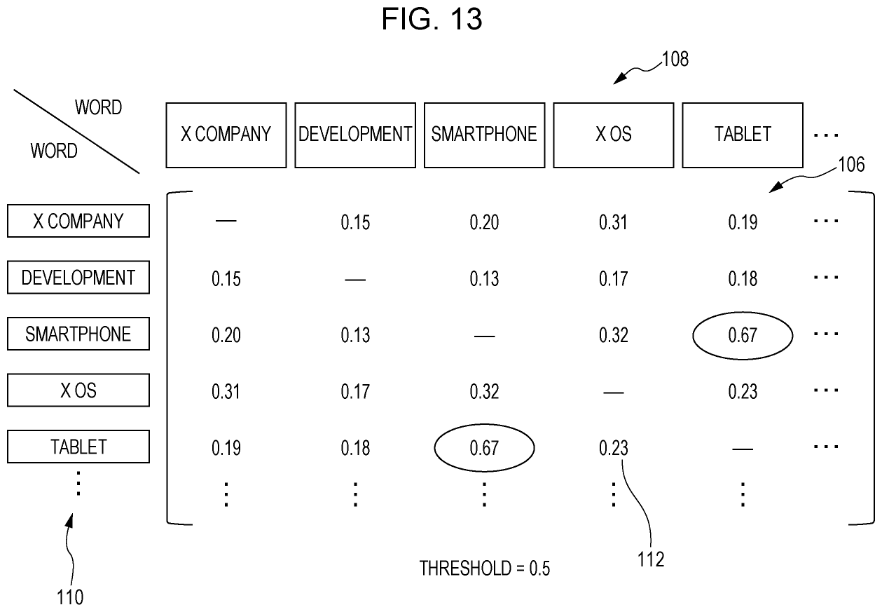

FIG. 13 illustrates an example of a similarity degree matrix generated by the word group structure generator. In the example illustrated, a similarity degree matrix 106 is formed by multiple similarity degrees 112. Word columns 108, 110 extracted from the descriptive text group are respectively arranged in the horizontal axis and the vertical axis of the similarity degree matrix. A similarity degree is calculated for each word pair. Pointwise mutual information (PMI) may be determined as the similarity degree. Alternatively, as the similarity degree, a cosine similarity degree may be calculated, or an index obtained by using Word2Vec may be calculated. It is also possible to utilize an edit distance as the similarity degree. In the example illustrated, a threshold value is set, and a similarity degree higher than or equal to the threshold value is referred to. For instance, an edge is set between a word pair having a similarity degree higher than or equal to the threshold value.

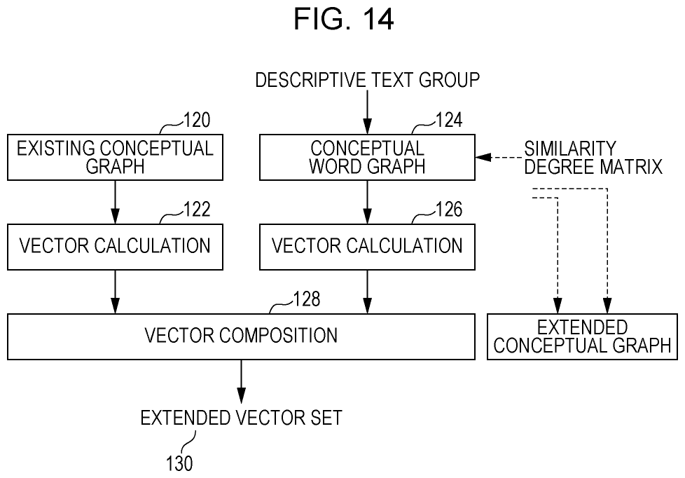

FIG. 14 illustrates a third exemplary embodiment. In the third exemplary embodiment, an extended conceptual graph is determined from the conceptual word graph by utilizing vector combining without generating a combined graph.

A first vector set is generated by applying vector calculation 122 based on publicly known vectorization technique to an existing conceptual graph 120. Meanwhile, similarly to the first exemplary embodiment and the second exemplary embodiment, a conceptual word graph 124 is generated based on the descriptive text group. At this point, a word group structure based on a similarity degree matrix may be incorporated. A second vector set is calculated by executing vector calculation 126 based on a conceptual word graph 124. The first and second vector sets calculated as described above are combined, thus an extended vector set 130 is generated as the combined vector set.

In vector combining 128, two vectors determined for individual concepts may be added, or the average of those may be calculated. It is to be noted that connection between those may be considered, however, a vector for a concept and a vector for an edge should have the same dimension as a precondition.

The extended vector set 130 (specifically, multiple vectors determined for multiple concepts and multiple edges) determined as described above reflects the relation between the new concept and the multiple existing concepts. Therefore, the extended vector set 130 is equivalent to the vector set calculated based on the above-described combined graph. In the third exemplary embodiment, as indicated by a symbol 131, a new edge is added to the existing conceptual graph based on the extended vector set 130, thus an extended conceptual graph is generated. For machine learning of each vector set, a network such as the GCN may be utilized.

FIG. 15 illustrates another example of an extended conceptual graph. The upper part of FIG. 15 illustrates the existing conceptual graph 10 and the new concept 20. The lower part illustrates an extended conceptual graph 32A. The extended conceptual graph 32A has newly set edges 34, 36 because of the relation to the new concept 20. In addition, the extended conceptual graph 32A has a portion 22D corresponding to the conceptual word graph. In this manner, the conceptual word graph 22 may be incorporated as part of the conceptual graph without being separated. When such incorporation is made, each word is treated as a concept.

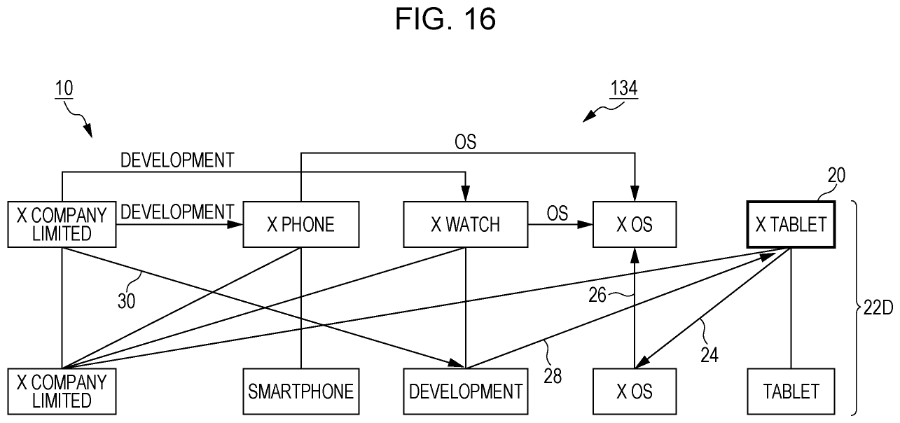

FIG. 16 illustrates a modification. A conceptual graph 134 according to the modification has a portion 22D which corresponds to an existing conceptual graph, a new concept, and a conceptual word graph. In the modification, a new edge to directly connect the new concept 20 to the existing conceptual graph 10 is not added, however, the edges 24, 26, 28, 30 corresponding to the new concept 20 are included in the portion 22D, thus the conceptual graph 134 as viewed in its entirety may be regarded as systematized knowledge including the new concept. Based on the conceptual graph 134, its distributed representation is obtained as needed.

FIG. 17 illustrates a specific example of an edge addition method. As already described, in the first exemplary embodiment and the second exemplary embodiment, a vector set is generated based on the combined graph including the existing conceptual graph. Each triple including the new concept is evaluated based on the vector set, and a new edge (in other words, a new relation) is identified from a result of the evaluation.

Specifically, on the assumption that a new concept is a subject (S) (however, it is a vector) as a precondition, a score is calculated for each triple by the following calculation expression.

score=|S−ri+oi| (2)

When the number of applicable triples, that is, the number of feasible combination of an object and a relation is m, the above-mentioned i can take each numerical value from 1 to m. Specifically, m score calculation expressions are indicated by a symbol 150 in FIG. 17. A symbol 154 indicates a vector for a new concept which is a subject. A symbol 156 indicates a vector for a relation which can be a predicate. For instance, when 100 types of relations are included in the existing conceptual graph, those relations are sequentially used. A symbol 158 indicates a vector for an existing concept which can be an object.

In addition, on the assumption that a new concept is an object (O) (however, it is a vector) as a precondition, a score is calculated for each triple by the following calculation expression.

score=|sj−rj+O| (3)

When the number of applicable triples, that is, the number of feasible combination of a subject and a relation is n, the above-mentioned i can take each numerical value from 1 to n. Specifically, n score calculation expressions are indicated by a symbol 152 in FIG. 17. A symbol 160 indicates a vector for a new concept which is an object. A symbol 162 indicates a vector for a new concept which can be a subject. A symbol 164 indicates a vector for a relation which can be a predicate. Similarly to what has been described above, for instance, when 100 types of relations are included in the existing conceptual graph, those relations are sequentially used.

As indicated by a symbol 166, one relation is selected by identifying a minimum score in (m+n) scores. As indicated by a symbol 168, an edge showing the relation is added to the existing conceptual graph as a new edge. Thus, an extended conceptual graph is generated. One or multiple relations are selected by identifying the scores lower than or equal to the threshold value in (m+n) scores, and accordingly, one or multiple new edges may be added to the existing conceptual graph. A relation may be selected in accordance with other conditions. An element to be applied to the calculation expression may be selected in advance based on the conceptual word graph. It is to be noted that in the third exemplary embodiment also, a new edge is added to the existing conceptual graph based on the extended vector set by the same technique described above.

In the embodiments above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device). In the exemplary embodiments above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A conceptual graph processing apparatus comprising
a processor configured to
based on a descriptive text group for a concept group consisting of a plurality of existing concepts included in an existing conceptual graph and a new concept not included in the existing conceptual graph, generate a conceptual word graph which represents a relation between the concept group and a word group included in the descriptive text group; and
generate an extended conceptual graph including the new concept based on the conceptual word graph.

2. The conceptual graph processing apparatus according to claim 1, wherein the processor
generates a matrix including elements representing a degree of connection between the concept group and the word group, and
generates the conceptual word graph based on the matrix.

3. The conceptual graph processing apparatus according to claim 2, wherein each of the elements is a numerical value which is calculated for each pair of a concept and a word, and indicates an importance degree of the word to the concept.

4. The conceptual graph processing apparatus according to claim 2, wherein the processor generates an intermediate structure based on the matrix, the intermediate structure including one or a plurality of edges between the concept group and the word group, and
the conceptual word graph includes the intermediate structure.

5. The conceptual graph processing apparatus according to claim 4, wherein the processor
calculates a plurality of similarity degrees indicating an inter-word relation in the word group,
generates a word group structure for the word group based on the plurality of similarity degrees, the word group structure including one or a plurality of edges, and
the conceptual word graph includes the intermediate structure and the word group structure.

6. The conceptual graph processing apparatus according to claim 1, wherein the processor
combines the existing conceptual graph and the conceptual word graph,
calculates a vector set for a plurality of graph elements included in the combined graph based on the combined graph, and
generates the extended conceptual graph by adding one or a plurality of new edges between the plurality of existing concepts and the new concept based on the vector set.

7. The conceptual graph processing apparatus according to claim 6, wherein the vector set is generated as a result of machine learning based on the combined graph.

8. The conceptual graph processing apparatus according to claim 1, wherein the processor
calculates a first vector set for the plurality of graph elements included in the existing conceptual graph based on the existing conceptual graph,
calculates a second vector set for the plurality of graph elements included in the conceptual word graph based on the conceptual word graph,
generates an extended vector set by combining the first vector set calculated for the existing conceptual graph and the second vector set calculated for the conceptual word graph, and
generates the extended conceptual graph based on the extended vector set.

9. The conceptual graph processing apparatus according to claim 8, wherein the first vector set is generated as a result of machine learning based on the existing conceptual graph, and
the second vector set is generated as a result of machine learning based on the conceptual word graph.

10. The conceptual graph processing apparatus according to claim 1, wherein the processor
performs pre-processing on the descriptive text group to replace words having a same meaning by a same word, and
generates the conceptual word graph based on the descriptive text group on which the pre-processing has been performed.

11. A non-transitory computer readable medium storing a program causing a computer to execute a process comprising:
based on a descriptive text group for a concept group consisting of a plurality of existing concepts included in an existing conceptual graph and a new concept not included in the existing conceptual graph, generating a conceptual word graph which represents a relation between the concept group and a word group included in the descriptive text group; and
generating an extended conceptual graph including the new concept based on the conceptual word graph.

12. A conceptual graph processing apparatus comprising
processing means for, based on a descriptive text group for a concept group consisting of a plurality of existing concepts included in an existing conceptual graph and a new concept not included in the existing conceptual graph, generating a conceptual word graph which represents a relation between the concept group and a word group included in the descriptive text group; and generating an extended conceptual graph including the new concept based on the conceptual word graph.
